(19) United States
(12) Patent Application Publication
(10) Pub. No.: US 2020/0100329 A1
(43) Pub. Date: Mar. 26, 2020

(54) HEATING SYSTEM FOR VEHICLE WHEEL FENDER

(71) Applicant: Magna Electronics Inc., Auburn Hills, MI (US)

(72) Inventor: Prathyush Kumar Keshipeddy, Auburn Hills, MI (US)

(21) Appl. No.: 16/583,301

(22) Filed: Sep. 26, 2019

Related U.S. Application Data
(60) Provisional application No. 62/736,480, filed on Sep. 26, 2018.

(51) Int. Cl. H05B 1/02; B62D 25/18; B60S 1/68

(52) U.S. Cl. CPC H05B 1/0236; B60S 1/68; B62D 25/18

(57) ABSTRACT

A vehicular wheel fender heating system includes a control at the vehicle and a heating element disposed at a wheel fender of a vehicle. The control is operable to electrically activate the heating element responsive to an input. Responsive to the input, such as an input indicative of presence or accumulation of snow or ice at the wheel fender, the control electrically activates the heating element to heat the wheel fender to melt snow or ice present thereat.

### CROSS REFERENCE TO RELATED APPLICATION

The present application claims the filing benefits of U.S. provisional application Ser. No. 62/736,480, filed Sep. 26, 2018, which is hereby incorporated herein by reference in its entirety.

### FIELD OF THE INVENTION

The present invention relates generally to a vehicle heating system.

### BACKGROUND OF THE INVENTION

In winter, snow often accumulates at the wheel fender and if the temperature drops, the accumulated snow forms ice. This effects the vehicle wheel motion and may even effect the turning radius if sufficient ice accumulates at the front wheel fenders. Often, the snow and ice has to be kicked to remove it from the wheel fenders.

### SUMMARY OF THE INVENTION

The present invention provides a heating system for a vehicle that utilizes a heating element disposed at each wheel fender (or at least at the front wheel fenders) of a vehicle. The heating element is activated to generate heat the respective wheel fender to melt snow and ice that accumulates at the wheel fender. The heating element may be activated responsive to a temperature sensor or via a user input in the vehicle or responsive to other types of sensors, such as a vision-based sensor that is used (via processing of image data captured by the vision-based sensor or camera) to determine presence of snow and ice at the wheel fender that is at or above a threshold level.

These and other objects, advantages, purposes and features of the present invention will become apparent upon review of the following specification in conjunction with the drawings.

### BRIEF DESCRIPTION OF THE DRAWINGS

FIGS. 1 and 2 are perspective views showing snow and ice accumulation at a vehicle wheel fender, and showing a heater element disposed at least partially along the wheel fender in accordance with the present invention; and

FIG. 3 is a block diagram of the wheel fender heating system of the present invention.

### DESCRIPTION OF THE PREFERRED EMBODIMENTS

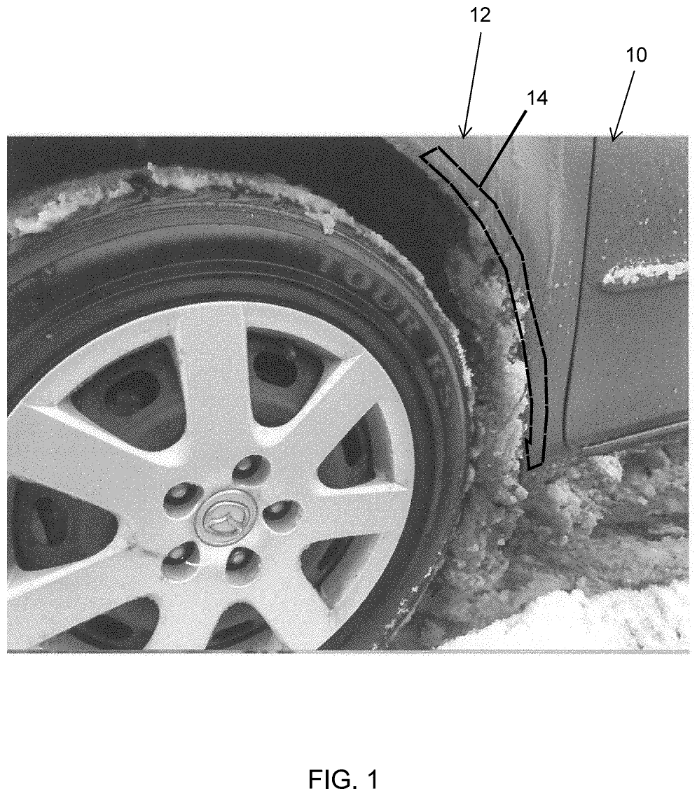

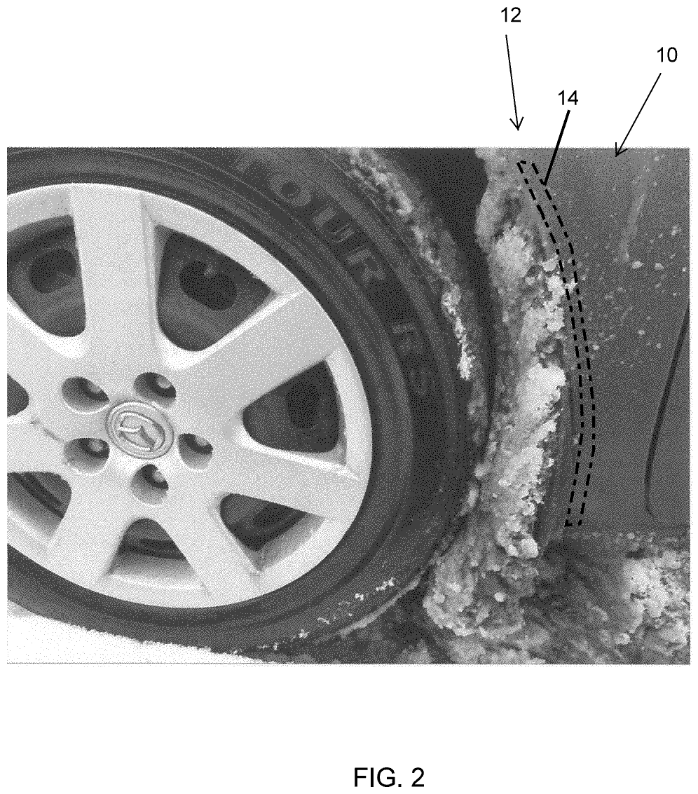

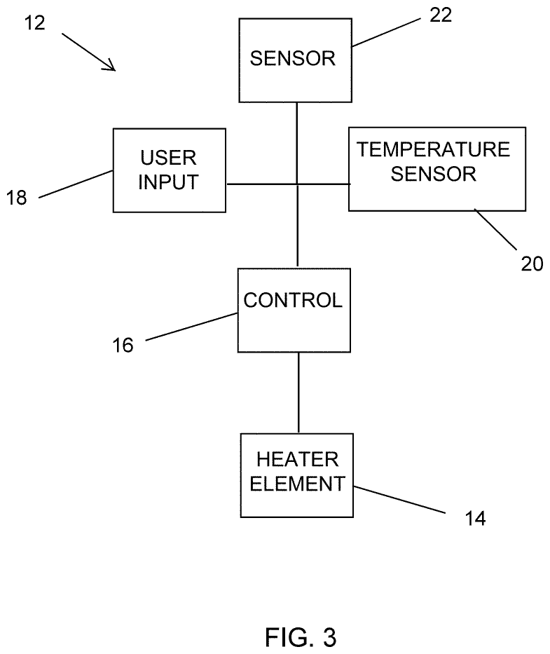

Referring now to the drawings and the illustrative embodiments depicted therein, a vehicle 10 includes a heating system 12 that includes a heating element 14 disposed at a wheel fender of the vehicle, such as at each wheel fender or at least at the front wheel fenders (FIGS. 1 and 2). The system 12 includes a control 16 that activates and deactivates the heating elements 14, such as responsive to a user input 18 or a temperature sensor 20 and/or any other suitable sensor 22 that may be used to sense the presence of snow or ice at the wheel fender (FIG. 3).

The trigger at which the control activates the heating element may comprise any suitable input or trigger. For example, the user input 18 may comprise a button or switch in the vehicle cabin, so a user or driver of the vehicle can activate the switch to start heating the wheel fender(s). The control, responsive to the input or trigger, may activate all of the heating elements (such as four heating elements, one at each wheel fender of a four-wheeled vehicle, or such as two heating elements, one at each front wheel fender where the steerable front wheels are located) or may only activate the front heating elements (at the front wheel fenders) independently from the rear heating elements (at the rear wheel fenders) or the like, depending on the particular application. Optionally, the control may individually and independently control or activate/deactivate the heating elements at each wheel fender of the vehicle, such as responsive to a temperature sensor at that wheel fender or such as responsive to an input indicative of accumulation of snow and/or ice at that wheel fender, as discussed below.

Optionally, and such as shown in FIG. 3, the trigger may comprise an output from the temperature sensor 20, whereby the control activates the heating element(s) when the temperature drops below a threshold temperature. In such an application, the heating elements may be activated before snow and ice accumulate in the wheel fender, and thus may limit or prevent or slow down accumulation of such snow and ice at the wheel fender. The temperature sensor may comprise an external temperature sensor of the vehicle, or may comprise a temperature sensor disposed at the respective wheel fender. The control thus may activate all of the heater elements responsive to a single temperature sensor or may individually and independently activate each heater element responsive to a respective temperature sensor at the respective wheel fender.

The control, responsive to the input or trigger, activates the heating element(s) to melt the snow or ice present at or accumulated at the wheel fender. The control may deactivate the heating element(s) following expiration of a period of time after the trigger or input (such as 15 minutes after the heating element(s) was/were activated or such as 30 minutes after the heating element(s) was/were activated or such as 1 hour after the heating element(s) was/were activated) or upon a temperature sensing of a temperature above an upper threshold temperature (where the upper threshold temperature is greater than the initial low temperature threshold), or responsive to actuation of another user input (or a second actuation of the same user input) or the like.

Thus, the heating system of the present invention provides a means for automatically reducing or removing snow and ice accumulation at the wheel fenders or wheel wells of the vehicle. The system thus avoids the manual task of cleaning snow and ice present at or accumulated at the wheel fenders. The system also reduces turning radius problems that may occur if sufficient snow or ice accumulates at or in the wheel fender. The system also reduces steering difficulties and even vehicle speed problems that may occur if sufficient snow or ice accumulates in the wheel fender. The system also may help to reduce tire wear and other tire problems that may occur if sufficient snow or ice is present at or accumulates in the wheel fender.

The heating element may comprise any suitable heatable or heat generating element that generates heat when powered or energized or activated. For example, the heating element may comprise a resistive wire or element (such as a polymeric film element having a plurality of electrically conductive traces established thereat) that generates heat when powered, with the wire making one or multiple passes along and close to the outer surface of the wheel fender or well. Optionally, for example, the heating element may comprise a coating or layer or film at the surface of the wheel fender or wheel well (such as an electrically conductive and resistive coating at a plastic surface of the wheel fender or at a metallic surface of the wheel fender), whereby the heating element heats responsive to electrical powering of the coating or layer or film (such as via applying an electrical current to the coating or layer or film so that heat is generated as current flows along or across the coating or layer or film). The heating element may be incorporated into the wheel fender to heat the wheel fender, or the heating element may be disposed at the surface of the wheel fender to generate heat at the outer surface with the heating element in more direct contact with the snow or ice, or the heating element may be disposed at the surface of the wheel well, with a protective film or layer disposed over the heating element. The heating element and heating system may utilize aspects of the systems described in U.S. Pat. Nos. 9,776,569; 9,481,304; 8,402,695 and/or 7,400,435 and/or U.S. Publication Nos. US-2018-0207691; US-2018-0079379; US-2017-0141461 and/or US-2015-0321621, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular wheel fender heating system comprising:
a heating element disposed at a wheel fender of a vehicle, the heating element generating heat when electrically activated;
a control at the vehicle, the control operable to electrically activate the heating element responsive to an input; and
wherein, responsive to the input, the control electrically activates the heating element to heat the wheel fender to melt snow or ice present thereat.

2. The vehicular wheel fender heating system of claim 1, wherein the input comprises a user actuatable input disposed in an interior cabin of the vehicle that is actuatable by a person in the vehicle.

3. The vehicular wheel fender heating system of claim 1, wherein the input comprises an input indicative of presence of snow or ice at the wheel fender.

4. The vehicular wheel fender heating system of claim 3, wherein the input is derived from an output of a temperature sensor at the vehicle, and wherein the control electrically activates the heating element responsive to the temperature sensor sensing an exterior temperature below a threshold temperature.

5. The vehicular wheel fender heating system of claim 4, wherein the temperature sensor is at the wheel fender of the vehicle.

6. The vehicular wheel fender heating system of claim 1, comprising a plurality of heating elements, each disposed at a respective wheel fender of the vehicle.

7. The vehicular wheel fender heating system of claim 1, wherein said control ceases electrical activation of the heating element responsive to expiration of a threshold period of time following electrical activation of the heating element.

8. The vehicular wheel fender heating system of claim 1, wherein said heating element comprises a resistive heating element that generates heat responsive to an electrical current passed therethrough.

9. The vehicular wheel fender heating system of claim 1, wherein said heating element is disposed at and along a surface of the wheel fender of the vehicle.

10. The vehicular wheel fender heating system of claim 9, wherein the wheel fender of the vehicle is spaced from a tire of a wheel of the vehicle, and wherein said heating element, when electrically activated, melts snow and ice present between the wheel fender of the vehicle and the tire.

11. A vehicular wheel fender heating system comprising:
a heating element disposed at a wheel fender of a vehicle, the heating element generating heat when electrically activated;
a temperature sensor disposed at the vehicle;
a control at the vehicle, the control operable to electrically activate the heating element responsive to an input;
wherein the input is derived from an output of the temperature sensor; and
wherein the control electrically activates the heating element to heat the wheel fender to melt snow or ice present thereat responsive to the temperature sensor sensing an exterior temperature below a threshold temperature.

12. The vehicular wheel fender heating system of claim 11, wherein the control is operable to electrically activate the heating element responsive to a user actuatable input disposed in an interior cabin of the vehicle that is actuatable by a person in the vehicle.

13. The vehicular wheel fender heating system of claim 11, wherein the temperature sensor is at the wheel fender of the vehicle.

14. The vehicular wheel fender heating system of claim 11, wherein said control ceases electrical activation of the heating element responsive to expiration of a threshold period of time following electrical activation of the heating element.

15. The vehicular wheel fender heating system of claim 11, wherein said heating element comprises a resistive heating element that generates heat responsive to an electrical current passed therethrough.

16. A vehicular wheel fender heating system comprising:
a plurality of heating elements, each disposed at a respective wheel fender of a vehicle, wherein each heating element of the plurality of heating elements generates heat when electrically activated;
a control at the vehicle, the control operable to electrically activate the heating elements responsive to an input;
wherein, responsive to the input, the control electrically activates the heating elements to heat the respective wheel fenders to melt snow or ice present thereat; and
wherein said control ceases electrical activation of the heating elements responsive to expiration of a threshold period of time following electrical activation of the heating elements.

17. The vehicular wheel fender heating system of claim 16, wherein the input comprises a user actuatable input disposed in an interior cabin of the vehicle that is actuatable by a person in the vehicle.

18. The vehicular wheel fender heating system of claim 16, wherein each heating element of the plurality of heating elements comprises a resistive heating element that generates heat responsive to an electrical current passed therethrough.

19. The vehicular wheel fender heating system of claim 16, wherein each heating element of the plurality of heating elements is disposed at and along a surface of the respective wheel fender of the vehicle.

20. The vehicular wheel fender heating system of claim 19, wherein the respective wheel fender of the vehicle is spaced from a respective tire of a wheel of the vehicle, and wherein each heating element of the plurality of heating elements, when electrically activated, melts snow and ice present between the respective wheel fender of the vehicle and the respective tire.
